(19) United States
(12) Patent Application Publication
(10) Pub. No.: US 2024/0391737 A1
(43) Pub. Date: Nov. 28, 2024

(54) SOLUTION FOR PROVIDING CONDITION DATA OF AN ELEVATOR ROPE

(71) Applicant: KONE Corporation, Helsinki (FI)

(72) Inventors: Juho KOKKALA, Helsinki (FI); Mirko RUOKOKOSKI, Helsinki (FI); Markus HARTIKAINEN, Helsinki (FI); Karthik SINDHYA, Helsinki (FI); Johan GRÖNHOLM, Helsinki (FI); Petteri VALJUS, Helsinki (FI); Tapani TYNI, Helsinki (FI)

(73) Assignee: KONE Corporation, Helsinki (FI)

(21) Appl. No.: 18/790,175

(22) Filed: Jul. 31, 2024

Related U.S. Application Data
(63) Continuation of application No. PCT/EP2022/055411, filed on Mar. 3, 2022.

(51) Int. Cl. B66B 7/12; B66B 1/34; B66B 5/00

(52) U.S. Cl. CPC B66B 7/1215; B66B 1/3446; B66B 5/0087

(57) ABSTRACT

The invention relates to a method for providing condition data of an elevator rope. The method comprises: using current state condition data representing a condition of the elevator rope for the length of the elevator rope in a current state and condition change data indicating at least one potential change in the condition of the elevator rope as input data of a rope condition model; processing the input data with the rope condition model to provide output data comprising condition data of the elevator rope in a new state; and utilizing the provided condition data of the elevator rope to update the current state condition data or in an elevator call allocation process. The invention relates also to an elevator computing system and a computer program product for providing condition data of an elevator rope.

### TECHNICAL FIELD

The invention concerns in general the technical field of elevators. Especially the invention concerns elevator ropes.

### BACKGROUND

Typically, an elevator group may comprise a plurality of elevator cars arranged to travel along respective elevator shafts. The operations of the elevator group are controlled by an elevator group control unit. The operations of the elevator group may comprise e.g. allocation of elevator calls of the elevator group. The allocation is typically performed by the elevator group control unit. Typically, the elevator group control unit takes into account in the elevator call allocation at least one objective, such as waiting time, journey time, energy consumption, and/or power peaks. The elevator group control unit may use an optimization principle, such as multi-objective optimization in the elevator call allocation.

However, the elevator group control unit does not pay any attention for example to wear of elevator ropes in the elevator call allocation process. The source of wear on the elevator ropes is mainly bendings of the elevator ropes, which occur when the elevator car moves, and the elevator ropes bend around pulleys and a traction sheave. Wearing of the elevator ropes and their lifetime is proportional to the number elevator rope bendings around the traction sheave and pulleys. The more bendings of the elevator ropes occur, the more the elevator ropes wear and the shorter the lifetime of the elevator ropes is.

When the elevator group operates normally, i.e. without taking the elevator rope wear into account in the allocation process, it may be possible that the bendings of the elevator ropes occur in an imbalanced way both within elevator ropes of a single elevator car and between elevator cars of the elevator group. This causes that the elevator ropes need to be changed even though parts of the elevator rope and/or elevator ropes of some elevator cars are still in good shape. In case of imbalanced elevator rope wear between elevator cars all elevator ropes shall be replaced at the same time because of requirements of standards. Moreover, a diameter and stiffness of the new elevator ropes are differentiating from old elevator ropes. Replacement of the elevator ropes is expensive and causes operation breaks and at least unnecessary site visits.

Thus, there is a need to further develop solutions for monitoring condition of elevator ropes.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator computing system, and a computer program for providing condition data of an elevator rope. Another objective of the invention is that the method, the elevator computing system, and the computer program for providing condition data of an elevator rope enable monitoring a condition of the elevator rope.

The objectives of the invention are reached by a method, an elevator computing system, and a computer program as defined by the respective independent claims.

According to a first aspect, a method for providing condition data of an elevator rope is provided, wherein the method comprises: using current state condition data representing a condition of the elevator rope for the length of the elevator rope in a current state and condition change data indicating at least one potential change in the condition of the elevator rope as input data of a rope condition model; processing the input data with the rope condition model to provide output data comprising condition data of the elevator rope in a new state; and utilizing the provided condition data of the elevator rope to update the current state condition data or in an elevator call allocation process.

The condition change data may comprise movement data of at least one realized movement cycle of the elevator car, and wherein the provided condition data may be utilized to update the current state condition data.

Alternatively, the condition change data may comprise movement data of at least one predicted movement cycle of the elevator car, and wherein the provided condition data may be utilized in the elevator call allocation process.

The method may further comprise discretizing the elevator rope by dividing the elevator rope into a plurality of rope segments.

Alternatively or in addition, the method may further comprise updating the provided condition data by using actual condition data of the elevator rope.

Alternatively or in addition, the method may further comprise training the rope condition model by using historical movement data of realized movement cycles and/or historical actual condition data.

The actual condition data and/or the historical actual condition data may be obtained by at least one rope condition monitoring sensor device arranged inside an elevator shaft and/or by a rope condition monitoring sensor device operated by a user during a maintenance visit.

The at least one rope condition monitoring sensor device may be a rope diameter monitoring device.

The condition of the elevator rope may be expressed as a rope condition count of the elevator rope for the length of the elevator rope or as rope diameter data representing a diameter of the elevator rope for the length of the elevator rope.

According to a second aspect, an elevator computing system for providing condition data of an elevator rope is provided, wherein the elevator computing system comprises: a processing unit comprising at least one processor; and a memory unit comprising at least one memory including computer program code; wherein the at least one memory and the computer program code are configured to, with the at least one processor, cause the elevator computing system to perform: use current state condition data representing a condition of the elevator rope for the length of the elevator rope in a current state and condition change data indicating at least one potential change in the condition of the elevator rope as input data of a rope condition model, process the input data with the rope condition model to provide output data comprising condition data of the elevator rope in a new state, and utilize the provided condition data of the elevator rope to update the current state condition data or in an elevator call allocation process.

The condition change data may comprise movement data of at least one realized movement cycle of the elevator car, and wherein the elevator computing system may be configured to utilize the provided condition data to update the current state condition data.

Alternatively, the condition change data may comprise movement data of at least one predicted movement cycle of the elevator car, and wherein the elevator computing system may be configured to utilize the provided condition data in the elevator call allocation process.

The elevator computing system may further be configured to discretize the elevator rope by dividing the elevator rope into a plurality of rope segments.

Alternatively or in addition, the elevator computing system may further be configured to update the provided condition data by using actual condition data the elevator rope.

Alternatively or in addition, the elevator computing system may further be configured to train the rope condition model by using historical movement data of movement cycles and/or historical actual condition data.

The actual condition data and/or the historical actual condition data may be obtained by at least one rope condition monitoring sensor device arranged inside an elevator shaft and/or by a rope condition monitoring sensor device operated by a user during a maintenance visit.

The at least one rope condition monitoring sensor device may be a rope diameter monitoring device.

The condition of the elevator rope may be expressed as a rope condition count of the elevator rope for the length of the elevator rope or rope diameter data representing a diameter of the elevator rope for the length of the elevator rope.

According to a third aspect, a computer program product for providing condition data of an elevator rope is provided, which computer program product, when executed by at least one processor, cause a computer to perform the method as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically an example of an elevator system.

FIGS. 1B and 1C illustrate schematically examples of roping arrangements of suspension ropes.

FIG. 2A illustrates schematically an example of an elevator rope divided into four rope segments.

FIG. 2B illustrates schematically an example of a rope bending count of the rope segments of the example elevator rope of FIG. 2A.

FIG. 3 illustrates schematically an example of a method for providing condition data of an elevator rope.

FIGS. 4A-4C illustrate schematically examples of providing condition data of an elevator rope by applying a rope condition model.

FIG. 4D illustrates schematically an example of a method for an elevator call allocation of an elevator group.

FIG. 4E illustrates schematically an example of updating condition data by applying a rope condition model.

FIG. 4F illustrates schematically an example of training of a rope condition model.

FIG. 5 illustrates schematically an example of components of an elevator group control unit.

FIG. 6 illustrates schematically an example of components of an external computing unit.

DESCRIPTION OF THE EXEMPLIFYING EMBODIMENTS

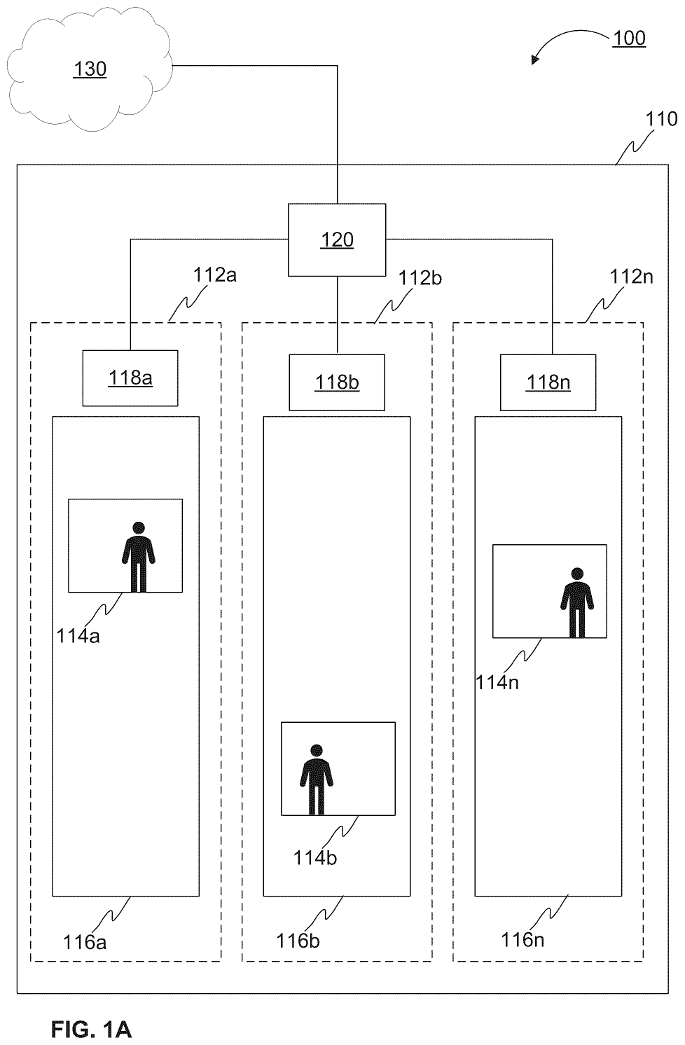

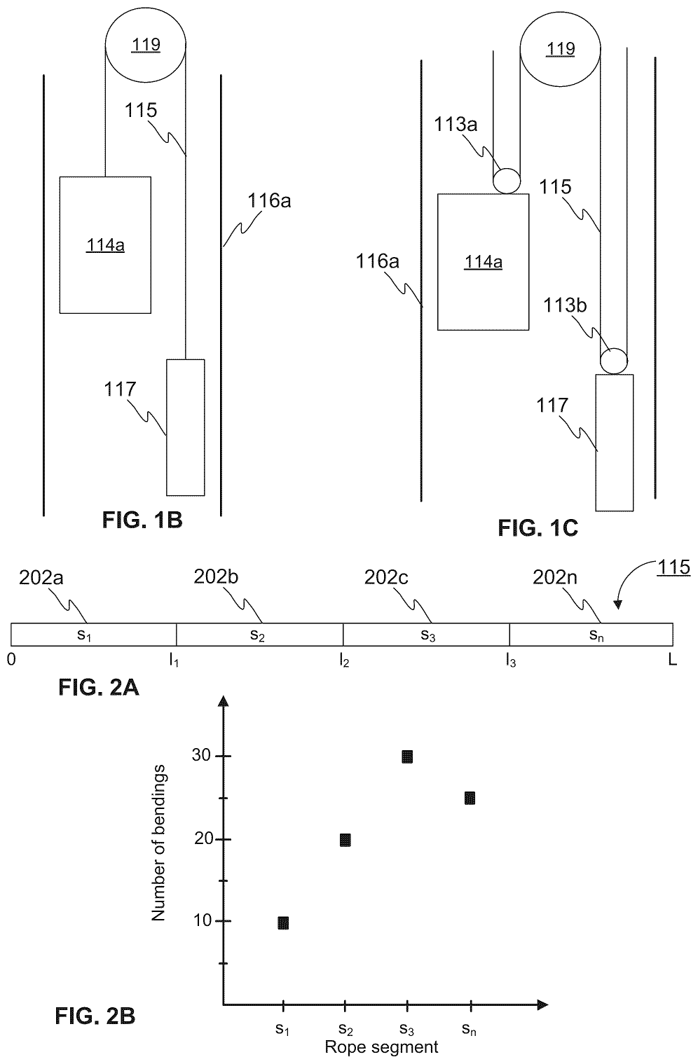

FIG. 1A illustrates schematically an example of an elevator system 100. The elevator system 100 may comprise at least one elevator group 110. The elevator group 110 may comprise a plurality of elevators, i.e. a group of two or more elevators, 112a-112n. Each elevator 112a-112n may comprise at least one elevator car 114a-114n arranged to travel along an elevator shaft 116a-116n. In other words, the elevator group 110 comprises a plurality of elevator cars 114a-114n, each arranged to travel along a respective elevator shaft 116a-116n. In the example of FIG. 1A each elevator 112a-112n comprises one elevator car 114a-114n. The plurality of elevator cars 114a-114n of the elevator group 110 is configured to operate as a unit serving same landings. In the example of FIG. 1A the elevator system 100 comprises one elevator group 110, which comprises three elevators 112a-112n. The elevator group 110 further comprises an elevator group control unit 120 configured to control operations of the elevator group 110 at least in part. Each elevator 112a-112n of the elevator group 110 comprises an elevator control unit 118a-118n configured to control operations of the respective elevator 112a-112n at least in part. The elevator group control unit 120 may be communicatively coupled to the elevator control unit 118a-118n of each elevator 112a-112n. The communication between the elevator group control unit 120 and the elevator control unit 118a-118n of each elevator 112a-112n may be based on one or more known communication technologies, either wired or wireless. Each elevator 112a-112n may further comprise one or more known elevator related entities, e.g. elevator hoisting machinery, safety circuit and devices, an elevator door system, one or more user interface devices, etc., which are not shown in FIG. 1A for sake of clarity.

The elevator system 100 may further be associated with at least one external computing unit 130. The term “external” in the context of the computing unit means throughout this application a computing unit being external to the elevator system 110. The at least one external computing unit 130 may be located on-site and/or off-site. The at least one external computing unit 130 may comprise a server, a cloud server, remote monitoring server, computing circuit, and/or any other computing device or a network of computing devices being external to the elevator system 100. The elevator group control unit 120 may be communicatively coupled to the at least one external computing unit 130. The communication between the elevator group control unit 120 and the at least one external computing unit 130 may be based on one or more known communication technologies, either wired or wireless.

Each elevator 112a-112n of the elevator group 110 comprises elevator ropes 115, which are not shown in FIG. 1A for sake of clarity. The elevator ropes may comprise suspension ropes 115 (i.e. hoisting ropes), compensating ropes, and governor ropes. The suspension ropes 115 are configured to carry, i.e. suspend, the elevator car 114a-114n so that the elevator car 114a-114n is in one end of the suspension ropes 115 and a counterweight 117 in the other end of the suspension ropes 115. The compensating ropes are configured to counterbalance, i.e. compensate, the weight of the suspension ropes. The compensating ropes run from the elevator car 114a-114n to the counterweight 117. The governor rope forms a continuous loop around a governor sheave and another weighted sheave at the bottom of the elevator shaft 116a-116n and is also attached to the elevator car 114a-114n and thus moves when the elevator car 114a-114n moves. A governor rope driven governor activates a safety gear when the elevator car 114a-114n moves at an overspeed. FIGS. 1B and 1C illustrate examples of roping arrangements of the suspension ropes 115. In the examples of 1B and 1C the example roping arrangements of the suspension ropes 115 of the elevator 112a of the elevator group 110 are shown from a side view, but similar example roping arrangements apply also to the suspension ropes of the other elevators 112b-112n of the elevator group 110. In FIG. 1B an example of a single wrap traction roping arrangement (i.e. a roping arrangement having a roping ratio of 1:1) is illustrated, wherein one end of the suspension ropes 115 is arranged to the elevator car 114a, the other end of the suspension ropes 115 is arranged to the counterweight 117, and the suspension ropes 115 travel over once the traction sheave 119. In the example of FIG. 1C an example of a double wrap traction roping arrangement (i.e. a roping arrangement having a roping ratio of 1:2) is illustrated, wherein the suspension ropes 115 are double wrapped around the traction sheave 119 and secondary sheaves 113a, 113b arranged to the elevator car 114a and the counterweight 117. In the examples of FIGS. 1B and 1C one suspension rope 115 is illustrated for sake of clarity, but also more than one parallel suspension ropes 115 may be used. The elevator ropes 115 wear during their lifetime. The source of wear on the elevator ropes 115 is mainly bendings of the elevator ropes 115, which occur when the elevator car 114a-114n travels along the shaft 116a-116n, and the elevator ropes 115 bend around pulleys, e.g. the secondary sheaves 113a, 113b, and the traction sheave 119. The wearing of the elevator ropes 115 and their lifetime is dependent on the number of bendings of the elevator ropes around the traction sheave and the secondary sheaves 113a, 113b. The more bendings of the elevator ropes 115 occurs, the more the elevator ropes 115 wear and the shorter the lifetime of the elevator ropes 115 is. Moreover, the number of bendings between different elevator ropes 115 of the elevator group 110 may be imbalanced. In other words, each elevator rope 115 of the elevator group 110 may have gathered different number of bendings than the other elevator ropes 115 of the elevator group 110. Similarly, the number of bendings within a single elevator rope 115 may be imbalanced. From now on the different embodiments are defined so that with the expression “elevator rope(s)” is preferably meant the suspension rope(s) 115. However, the embodiments may also be implemented with the compensating ropes and/or the governor ropes.

The elevator system 100 may further comprise rope condition monitoring sensor devices arranged inside the elevator shafts 116a-116n of the elevator group 110 and configured to provide actual condition data of the elevator ropes 115 or at least part of the elevator ropes 115 representing the actual condition of the elevator ropes 115 or the at least part of the elevator ropes 115. In other words, at least one rope condition monitoring sensor device may be arranged inside each elevator shaft 116a-116n of the elevator group 110 to obtain the condition data of the elevator ropes 115 residing inside the respective elevator shaft 116a-116n. The at least one rope condition monitoring sensor device may be arranged inside each elevator shaft 116a-116n so that it is capable to obtain the actual condition data of at least one elevator rope 115 residing inside said elevator shaft 116a-116n. For example, a rope condition monitoring sensor device may surround the elevator rope 115 to be monitored. The rope condition monitoring sensor device may for example be, but is not limited to, arranged, e.g. fixed, to the elevator hoisting machinery or a bedplate. For sake of clarity the at least one rope condition monitoring sensor device is not shown in FIGS. 1A-1C. The rope condition monitoring sensor devices may be configured to provide the obtained actual condition data to the elevator group control unit 120 directly or via the respective elevator control unit 118a-118n. The elevator group control unit 120 may be configured to provide the obtained actual condition data to the external computing unit 130, if needed. The rope condition monitoring sensor devices may for example be rope diameter monitoring devices. In that case the actual condition data may comprise rope diameter data representing the actual diameter of the elevator ropes 115 or the at least part of the elevator ropes 115.

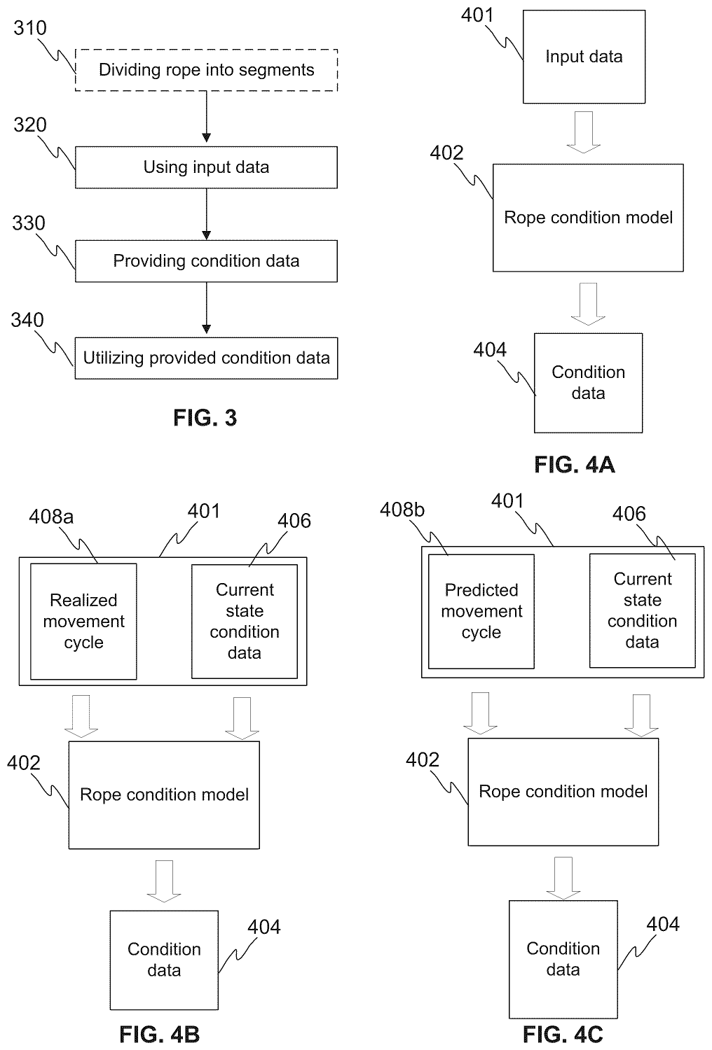

Next an example of a method for providing condition data of an elevator rope 115 is described by referring to FIG. 3, which illustrates the method as a flow chart. Preferably, in this example method the elevator rope 115 may be a suspension rope. However, the elevator rope 115 may also be a compensating rope or a governor rope. The method may be performed, i.e. executed, by an elevator computing system, i.e. the method is a computer implemented method. The elevator computing system may comprise at least one elevator control unit 118a-118n, the elevator group control unit 120, and/or the external computing unit 130.

The method may be based on modelling the condition of the elevator rope 115 for the length of the elevator rope 115. According to an example, the method may be based on a discretized model. The discretized model may be for the elevator rope 115, i.e. a discretized model of the elevator rope, or for a corresponding travel along the elevator shaft 116a-116n travelled by of the elevator car 114a-114n, i.e. a discretized model of the travel of the elevator car 114a-114n along the elevator shaft 116a-116n. For example, at a step 310 the elevator rope 115 may be discretized, i.e. segmented, by dividing the elevator rope 115 in a length direction into a plurality of rope segments 202a-202n (s₁, s₂, s₃, . . . , sₙ). For example, the length of the elevator rope [0, L] may be discretized into N rope segments [0, I₁], [I₁, I₂], . . . , [I_{(N-1)}, L], where N is a finite number. Alternatively, at a step 310 the travel of the elevator car 114a-114n along the elevator shaft 116a-116n may be discretized, i.e. segmented, by dividing the travel into a plurality of travel segments. As discussed above, the elevator rope 115 bends around the pulleys and the traction sheave 119, when the elevator car 114a-114n travels along the elevator shaft 116a-116n. Thus, the condition of the elevator rope 115 may also be modelled by using the discretized model of the travel of the elevator car 114a-114n along the elevator shaft 116a-116n. From now on in this application with the term “rope segment(s)” is meant the (rope) segment(s) of the discretized elevator rope 115 and also the (travel) segment(s) of the discretized travel of the elevator car 114a-114n along the elevator shaft 116a-116n. FIG. 2A illustrates an example of an example elevator rope 115 divided into four rope segments (s₁, s₂, s₃, and sₙ) 202a-202n in the length direction of the elevator rope 115. Length of the first rope segment 202a is I₁, length of the second rope segment 202b is I₂-I₁, length of the third rope segment 202c is I₃-I₂, and length of the fourth rope segment is L-I₃. FIG. 2B illustrates schematically an example of the number of bendings of the rope segments 202a-202n of the example elevator rope 115 of FIG. 2A. The number of bendings are used in the example of FIG. 2B as an example to illustrate the condition of the elevator rope 115. The number of occurred bendings in the first rope segment 202a (s₁) is 10, the number of occurred bendings in the second rope segment 202b (s₂) is 20, the number of occurred bendings in the third rope segment 202c (s₃) is 30, and the number of occurred bendings in the fourth rope segment 202n (sₙ) is 25. FIG. 2B shows that the number of bendings may be unbalanced between the segments 202a-202n of the single example elevator rope 115. The number of the plurality of rope segments 202a-202n may depend on the desired accuracy of the provided condition data of an elevator rope 115 and/or on the available computing capacity. The more densely the elevator rope 115 is segmented (i.e. the higher the number of the plurality of rope segments 202a-202n is), the more accurately the condition data of an elevator rope 115 may be provided, but also the more computing capacity is required. Alternatively, the method may be based on a continuous model of the elevator rope 115. For example, a basis function approach may be used in the continuous model of the elevator rope 115. Although the examples of the method for providing the condition data of the elevator rope 115 are mainly described by using the discretized elevator rope 115, the method is not limited to that, and also the continuous model of the elevator rope 115 may be used.

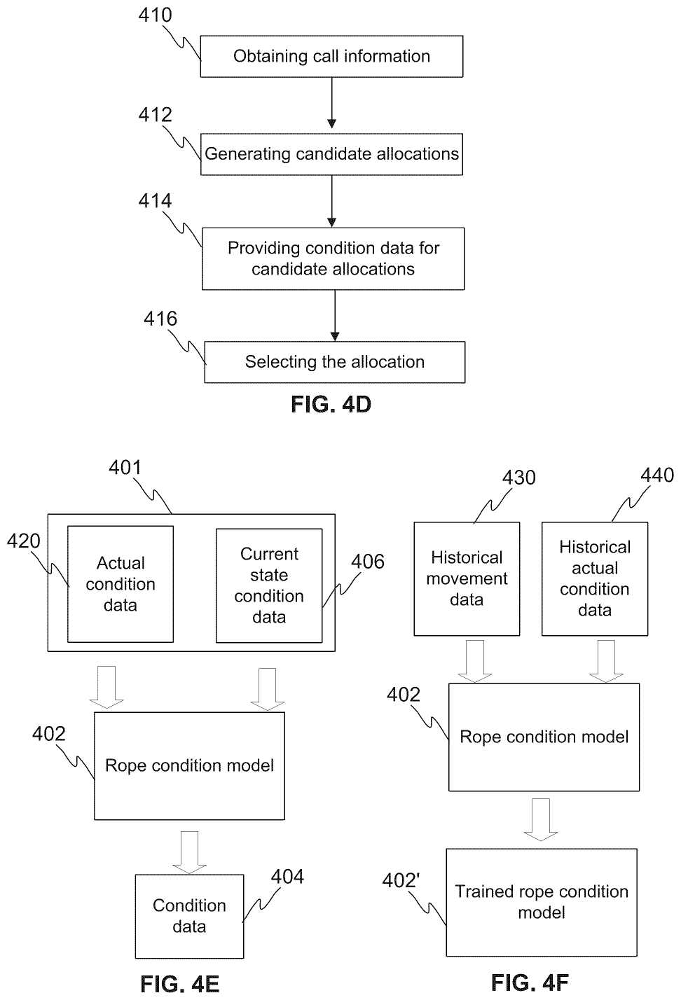

At a step 330, the elevator computing system 118a-118n, 120, 130 provides condition data 404 of the elevator rope 115 in a new state, by applying a rope condition model 402. The condition data 404 of the elevator rope 115 in the new state represents a condition of the elevator rope 115 for the length of the elevator rope 115 in the new state. For example, in case of the discretized model of the elevator rope 115, at the step 330 the elevator computing system 118a-118n, 120, 130 provides the condition data 404 of each rope segment 202a-202n of the elevator rope 115 in the new state by applying the rope condition model 402. At a step 320 current state condition data 406 representing a condition of the elevator rope 115 for the length of the elevator rope 115 in a current state and condition change data 408a, 408b indicating at least one potential change in the condition of the elevator rope 115 are used as input data 401 of a rope condition model 402. The current state precedes the new state, e.g. a subsequent state. In other words, the new state, e.g. a subsequent state, follows the current state. For example, the new state of the elevator rope 115 may follow the current state of the elevator rope 115 due to the at least one potential change in the condition of the elevator rope 115. According to an example, the current state condition data 406 may for example comprise the condition data 404 provided previously with the rope condition model 402, e.g. at a previous state preceding the current state. At the step 330 the input data 401 is processed with the rope condition model 402 to provide, i.e. generate, output data comprising the condition data 404 of the elevator rope 115 in the new state. In other words, the elevator computing system 118a-118n, 120, 130 is able to predict or estimate by applying the rope condition model 402 the condition data 404 representing a numerical estimation the condition of the elevator rope 115 in the new state, i.e. what is the estimated condition of the elevator rope in the new state. For example, a Kalman filter prediction type algorithm may be used to provide the condition data 404 in the new state. FIG. 4A illustrates schematically a simple example of providing the condition data 404 in the new state by using the rope condition model 402. For example, the rope condition model 402 may be a linear-Gaussian state-space model and the condition data 404 in the new state may for example be a probability distribution, e.g. a multivariate Gaussian distribution. Instead of a piecewise discretization, the rope condition model 402 may alternatively apply a continuous Gaussian process e.g. by using the basis function approach. Alternatively, nonlinear versions (suitably linearized) may also be applied. The probabilistic state-space model approach is given only one example and any other models, e.g. machine learning models, such as splines model approach, may also be used. According to an example, predefined layout data may be used as pre-information for the rope condition model 402. The predefined layout data may comprise a layout of each elevator 112a-112n of the elevator group 110. The layout of each elevator 112a-112n may represent a mechanical roping configuration data of said elevator 112a-112n. The mechanical roping configuration data of each elevator 112a-112n may comprise for example location data of the traction sheave 119 and possibly also location data of the secondary sheaves 113a, 113b (if the secondary sheaves 113a, 113b are comprised in the roping arrangement) as a function of a location of the elevator car 114a-114n inside the elevator shaft 116a-116n, and/or diameter data of the elevator rope 115. The location data of the traction sheave 119 as the function of the location of the elevator car 114a-114n inside the elevator shaft 116a-116n may represent the location of the traction sheave in relation to the elevator rope 115 as a function of a location of the elevator car 114a-114n inside the elevator shaft 116a-116n. Similarly, the location data of the secondary sheaves 113a, 113b as the function of the location of the elevator car 114a-114n inside the elevator shaft 116a-116n may represent the locations of the secondary sheaves 113a, 113b in relation to the elevator rope 115 as a function of a location of the elevator car 114a-114n inside the elevator shaft 116a-116n.

The condition of the elevator rope 115 may be expressed as a rope condition count of the elevator rope 115 for the length of the elevator rope 115. The rope condition count defines numerically the condition of the elevator rope 115. For example, the rope condition count may be expressed in percentage values so that 100% means that the elevator rope 115 has a perfect condition and 0% means that the elevator rope 115 is broken. When the condition of the elevator rope 115 is expressed as the rope condition count, the provided condition data 404 in the new state may comprise the rope condition count for the length of the elevator rope 115 in the new state and the current state condition data 406 may comprise the rope condition count for the length of the elevator rope 115 in the current state. For example, in case of discretized elevator rope 115, the provided condition data 404 in the new state may comprise the rope condition count of each rope segment 202a-202n in the new state and the current state condition data 406 may comprise the rope condition count of each rope segment 202a-202n in the current state. According to another example, the condition of the elevator rope 115 may be expressed as rope diameter data representing a diameter of the elevator rope 115. When the condition of the elevator rope 115 is expressed as the rope diameter data, the provided condition data 404 in the new state may comprise the rope diameter data for the length of the elevator rope 115 in the new state and the current state condition data 406 may comprise the rope diameter data for the length of the elevator rope 115 in the current state. For example, in case of discretized elevator rope 115, the provided condition data 404 in the new state may comprise the rope diameter data representing the diameter of each rope segment 202a-202n in the new state and the current state condition data 406 may comprise the rope diameter data representing the diameter of each rope segment 202a-202n in the current state.

At a step 340, the elevator computing system 118a-118n, 120, 130 utilizes the provided condition data 404 of the elevator rope 115 to update the current state condition data 406 or in an elevator call allocation process depending on the condition change data. The utilization of the provided condition data 404 to update the current state condition data 406 is discussed more in detail later in this application by referring to FIG. 4B. The utilization of the provided condition data 404 in the elevator call allocation process is discussed more in detail later in this application by referring to FIGS. 4C and 4D.

As discussed above, the condition change data indicates 408a, 408b at least one potential change in the condition of the elevator rope 115. The condition change data may comprise movement data of at least one movement cycle 408a, 408b of the elevator car 114a-114n. The at least one movement cycle 408a, 408b of the movement data may comprise at least one realized movement cycle 408a or at least one predicted movement cycle 408b. The at least one realized movement cycle 408a represents at least one actual realized movement cycle executed by the elevator car 114a-114n. The at least one predicted movement cycle 408b represents at least one movement cycle that has not been realized (at least yet but may possibly be realized later). According to an example, the at least one predicted movement cycle 408b may be utilized in an elevator call allocation process. An example of utilizing the predicted at least one movement cycle in the elevator call allocation process will be discussed later referring to FIG. 4D. The at least one movement cycle 408a, 408b of the elevator car 114a-114n may cause that one or more of the rope segments 202a-202n will be bent around the traction sheave 119 and/or the secondary sheaves 113a, 113b due to movement of the elevator car 114a-114n and thus cause at least one potential change in the condition of the elevator rope 115. One movement cycle 408a, 408b of the elevator car 114a-114n corresponds to a movement of the elevator car 114a-114n from a floor to another floor. The movement data of each movement cycle 408a, 408b may for example comprise starting time (i.e. timestamp) of said movement cycle, an elevator identifier (ID) identifying the elevator car 114a-114n, an origin landing of said movement cycle, a destination landing of said movement cycle, a load data of the elevator car 114a-114n, and/or one or more other movement factors.

An example of providing the condition data 404 in the new state by using the movement data of at least one realized movement cycle 408a of the elevator car 114a-114n and the current state condition data 406 as the input data of the rope condition model 402 is illustrated in FIG. 4B. The current state condition data 406 may represent the condition of the elevator rope 115 at the current state, i.e. at a state before the at least one realized movement cycle 408a of the elevator car 114a-114n. When the movement data of the at least one realized movement cycle 408a is used, the provided condition data 404 in the new state represents an estimated condition of the elevator rope 115 after the at least one realized movement cycle 408a. In other words, the provided condition data 404 in the new state may represent an estimation how the condition of the elevator rope 115 changes after the at least one realized movement cycle 408a of the elevator car 114a-114n occurs. The provided condition data 404 in the new state may be used to update the current state condition data 406 to be used for providing the condition data 404 of the elevator rope 115 in a subsequent new state by applying the rope condition model 402. In other words, the current state condition data 406 may be replaced with the provided condition data 404 in the new state to be used for the estimation of the condition of the elevator rope 115 in the subsequent new state. This enables maintaining the current state condition data 406 up to date, i.e. updated, according to the at least one realized movement cycle of the elevator car 114a-114n.

An example of providing the condition data 404 in the new state by using the movement data of at least one predicted movement cycle 408b of the elevator car 114a-114n and the current state condition data 406 as the input data of the rope condition model 402 is illustrated in FIG. 4C. When the movement data of the at least one predicted movement cycle 408b is used, the provided condition data 404 in the new state represents the estimated, i.e. predicted, condition of the elevator rope 115 after the at least one predicted movement cycle 408b. In other words, the estimated condition of the elevator rope 115 may represent an estimation how the condition of the elevator rope 115 would change, if the at least one predicted movement cycle 408b of the elevator car 114a-114n would occur. The rope condition model 402 may be used in this example as if in a simulation mode. However, in the simulation mode the at least one predicted movement cycle 408b will not be realized (at least yet but may possibly be realized later) and the current state condition data 406 will not be updated as in the case of using the at least one realized movement cycle 408a discussed above. According to an example, the simulation mode may be utilized in the elevator call allocation process. An example of utilizing the condition data 404 in the new state provided by using the movement data of at least one predicted movement cycle 408b in the elevator call allocation process is described next referring to FIG. 4D.

At a step 410, the elevator computing system 118a-118n, 120, 130 may obtain call information indicative of at least one generated elevator call, i.e. at least one currently existing, i.e. open, elevator call. The call information may be obtained in response to receiving at least one new elevator call or in response to detecting a need to reallocate all open elevator calls. The at least one new elevator call may for example be generated in response to a user interaction, e.g. by pushing of an elevator user interface button by a user, via a user interface, e.g. a landing call panel, a car operating panel, a destination operating panel, or any other user interface device capable for generating the elevator calls. For sake of clarity the user interface is not shown in FIG. 1A. The call information may be provided to the elevator group control unit 120 from the user interface directly or via at least one of the elevator control systems 118a-118n. The elevator group control unit 120 may provide the call information to the external computing unit 130, if needed. The at least one elevator call may be an elevator car call, a landing call, and/or a destination call. The elevator car call may comprise a request to drive an elevator car 114a-114n to a destination landing. The elevator car calls are not allocated as the elevator car call must be served by the elevator car 114a-114n from where the elevator car call is generated. However, the currently existing elevator car calls are taken into account in the allocation of other elevator calls. Therefore, the obtained call information may comprise also indication of at least one generated elevator car call. The landing call may comprise a request to drive an elevator car 114a-114n to a landing from which the elevator call is generated. The destination call may comprise a request to drive an elevator car 114a-114n from a landing from which the elevator call is generated to a destination landing.

At a step 412, in response to obtaining the call information, the elevator computing system 118a-118n, 120, 130 may generate a plurality of candidate allocations. Each generated candidate allocation may comprise one or more possible candidate routes for one or more available elevator cars 114a-114n of the elevator group 110. A single candidate allocation belonging to the plurality of candidate allocations may comprise allocations of all currently existing elevator calls indicated in the obtained call information. The single candidate allocation may imply one or more candidate routes for each of the one or more available elevator cars 114a-114n. A single candidate route for one elevator car 114a-114n may comprise a plurality of predicted movement cycles 408b. In addition to the plurality of candidate allocations generated in response to the receiving the call information, there may already exist one or more previously generated candidate allocations that may be included in the candidate allocations in the following steps of the elevator call allocation process.

At a step 414, the elevator computing system 118a-118n, 120, 130 may provide the condition data 404 in the new state for each candidate allocation by applying the rope condition model 402, wherein the movement data of the plurality of predicted movement cycles 408b involved in said candidate allocation and the current state condition data 406 are used as the input data of the rope condition model 402 as discussed above referring to FIG. 4C, but taking into account each elevator rope 115 of the elevator group 110 involved in said candidate allocation. In other words, for each candidate allocation the elevator computing system 118a-118n, 120, 130 provides the condition data 404 in the new state representing the estimated condition of the elevator ropes 115 in the new state, i.e. an estimation how the condition of the elevator ropes 115 would change, if the plurality of predicted movement cycles 408b involved in said candidate allocation would occur. In the elevator call allocation process the condition data 404 in the new state may be provided for each elevator rope 115 involved in each candidate allocation similarly as discussed above by referring to FIG. 4C, wherein the condition data 404 of one elevator rope 115 in the new state provided.

At a step 416, the elevator computing system 118a-118n, 120, 130 may defining a rope condition-based allocation objective for each candidate allocation by utilizing the current condition state data 406 of each elevator rope 115 involved in said candidate allocation and the condition data 404 in the new state provided for each elevator rope 115 involved in said candidate allocation at the step 414. The elevator computing system 118a-118n, 120, 130 may then select the allocation for the at least one elevator call from among the candidate allocations based on the defined rope condition-based allocation objective and at least one other allocation objective. The at least one other allocation objective may comprise for example waiting time data, journey time data, energy consumption data, and/or power peak data. Selecting the allocation for the elevator call may be performed by using a multi-objective optimization framework. An example of the multi-objective optimization framework is disclosed in a patent publication EP 1 368 267 B1. The use of the rope condition-based allocation objective defined for each candidate allocations as one allocation objective for the selection of the allocation for the elevator call in addition to at least one other allocation objective, enables that the wear of the elevator ropes 115 may be taken into account in the allocation of the at least one elevator call of the elevator group 110. Moreover, this enables increasing elevator rope lifetime by balancing in the elevator call allocation rope wear both between different elevator ropes and within a single elevator rope, thus minimizing resource consumption and unnecessary maintenance visits. Moreover, this enables to take into account which parts (i.e. rope segments) of the elevator rope would get wear in the candidate routes, thereby making better decisions as not all distance traveled by the elevator car is equal in terms of elevator rope wear.

Alternatively or in addition, according to an example, the condition data 404 may be updated by applying the rope condition model 402 and by using actual condition data 420 of the elevator rope 115. An example of updating the condition data 404 by using the input data of the rope condition model 402 comprising the current state condition data 406 and the actual condition data 420 of the elevator rope 115 is illustrated in FIG. 4E. When the actual condition data 420 is used as a part of the input data 401 of the rope condition model 402 to update the provided condition data 404, the rope condition model 402 may be considered as a rope condition observation model because it is used to update the condition data 404 by using observed condition data, i.e. the actual condition data 420. The provided condition data 404 may for example start to vary from the modelled condition of the elevator rope 115 over the time for example due a spatial variation in the condition of the elevator rope 115. The condition of the elevator rope 115 may also depend for example on elevator shaft conditions (e.g. moisture, temperature, etc.) and/or lubrication of the elevator rope 115. By using the actual condition data 420 of the elevator rope 115 to update the condition data 404, the accuracy of the provided condition data 404 may be improved. It enables also that the provided condition data 404 may be maintained up to date, i.e. updated, according to the actual condition data 420 of the elevator rope 115. For example, in case of discretized elevator rope 115 the actual condition data 420 of the elevator rope 115 may comprise actual condition data of one or more rope segments 202a-202n. The actual condition data 420 may for example comprise a rope condition count of the elevator rope 115 for the length of the elevator rope 115 or rope diameter data representing a diameter of the elevator rope 115 for the length of the elevator rope 115. The actual condition data 420 may be obtained by the rope condition monitoring sensor devices arranged inside the elevator shafts 116a-116n and/or the rope condition monitoring sensor device operated by the user during the maintenance visit.

Alternatively or in addition, according to another example, the rope condition model 402 may be trained, i.e. updated, by using historical movement data 430 of realized movement cycles and/or historical actual condition data 440. FIG. 4F illustrates an example of training of the rope condition model 402. As a result of the training of the rope condition model a trained rope condition model, i.e. updated rope condition model, 402′ may be generated. If the rope condition model 402 is considered as the rope condition observation model as discussed above, the rope condition observation model may also be trained similarly as described here referring to the rope condition model 402. The historical movement data 430 of the realized movement cycles and the historical actual condition data 440 may be gathered in the long term during the operation of the elevator group 110. The elevator group control unit 120 may obtain the historical movement data 430 of the realized movement cycles for example from the elevator control systems 118a-118n of the elevator group 110. The elevator group control unit 120 may provide the obtained historical movement data 430 of the realized movement cycles to the external computing unit 130, if needed. The elevator group control unit 120 may obtain the historical actual condition data 440 for example from the at least one rope condition monitoring sensor device directly or via the elevator control systems 118a-118n of the elevator group 110. The elevator group control unit 120 may provide the obtained historical actual condition data 440 to the external computing unit 130, if needed. When the rope condition model 402, 402′ is trained properly, the accuracy of the generated output of the rope condition model 402, 402′, e.g. the condition data 404, may be increased.

Next a non-limiting example of the providing, i.e. predicting, the condition data 404 in the new state by applying the rope condition model 402 is described. In this example, the rope condition model 402 is a linear-Gaussian state-space model. As discussed above the rope length [0, L] is discretized into N segments [0, I₁], [I₁, I₂], . . . , [I_{N-1}, L]. The current state condition data 406 of the elevator rope 115 may be modeled as a Gaussian distribution over an N-dimensional vector,

$$c \sim N ( {m}_{c} , {P}_{c} ) ,$$

where N refers to normal distribution, the ith component of a (unobserved) vector c describes a true condition of the ith rope segment (i.e. the actual condition of the ith rope segment), the ith component of a vector m_{c} (maintained in the model) defines the estimated current condition of the ith rope segment, and the (i,j)th component of a matrix P_{c} is the covariance of the current condition of the ith rope segment and the current condition of the jth rope segment, i.e. P_{c} describes error margins of the estimated current condition. The current state condition data 406 may comprise in this example the pair m_{c}, P_{c}. In this example, the rope condition model 402 uses as input the current state condition data (m_{c},P_{c}) and the movement data 408a, 408b. A Kalman filter prediction type step is performed to provide a new state distribution, i.e. the provided condition data 404 of the elevator rope 115 in the new state (mₙ,Pₙ):

$${m}_{n} = {Am}_{c} + a , \\ {P}_{n} = {AP}_{c} {A}^{T} + Q ,$$

where A is a state transition matrix, a is a state transition vector, and Q is a noise covariance matrix. The state transition matrix A, the state transition vector a, and the noise covariance matrix Q depend on the movement data 408a, 408b. The training of the rope condition model 402 may for example comprise using the historical movement data and/or the historical actual condition data for defining a mapping from the historical movement data to the matrices A, and Q and the vector a. According to a simplified non-limiting example, if it is expected that the rope condition count of an example rope segment k is decreased by one unit (e.g. −1) on average for each movement cycle that said rope segment k is bent (and everything else is assumed to be constant), the state transition matrix A is an identity matrix and the state transition vector a is a vector with kth component −1 and other components 0. The movement cycle determines which segments are bent and the mapping translates this information into the vector a. In the training phase of the rope condition model 402, it may for example be learned from the historical movement data and/or the historical actual condition data, that a certain movement cycle, e.g. from floor 2 to floor 3, on average decreases the rope condition count of the rope segment k by two units (e.g. −2) rather than the expected one unit (e.g. −1). The mapping may then be changed so that in the future the movement cycle from the floor 2 to the floor 3 maps to the vector a with −2 in the kth component. Then, after the training, when the rope condition model 402 is used with the movement cycle from the floor 2 to the floor 3, the corresponding rope condition count in the provided condition data 404 is the rope condition count in the current state condition data decreased by two units (rather than one unit as it would have been before the training).

Next a non-limiting example of the updating the condition data 404 in the new state by applying the rope condition (observation) model 402 by using the actual condition data 420 is described. In this example the actual condition data 420 may be obtained by using the rope condition monitoring sensor device. A Kalman filter updating type step may be performed to provide the updated condition data 404 of the elevator rope 115 (mₙ,Pₙ):

$${m}_{n} = {m}_{c} + K ( y - {Hm}_{c} ) , \\ {P}_{n} = {P}_{c} + {KSK}^{T} ,$$

where the (m_{c},P_{c}) is the current state condition data 406 (before the updating), (mₙ,Pₙ) is the provided (i.e. updated) condition data 404, y is the actual condition data 420, K is a Kalman gain, Sis a covariance matrix of the actual condition data, and H depends on which part(s) of the elevator rope 115 the rope condition monitoring sensor device is measuring. The Kalman gain K and the covariance matrix S may be defined based on the following equations:

$$S = {HP}_{c} {H}^{T} + R , \\ K = {P}_{c} {H}^{T} {S}^{- 1} ,$$

where R is a sensor error covariance.

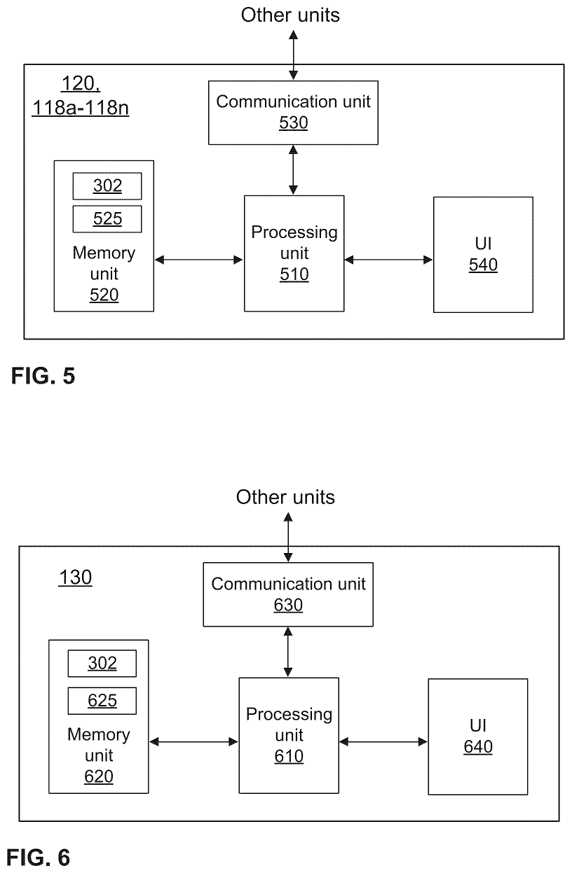

FIG. 5 illustrates schematically an example of components of an elevator control unit. The elevator control unit may be for example the elevator group control unit 120 or the at least one elevator control unit 118a-118n. The elevator control unit 118a-118n, 120 may comprise a processing unit 510 comprising one or more processors, a memory unit 520 comprising one or more memories, a communication interface unit 530 comprising one or more communication devices, and possibly a user interface (UI) unit 540. The mentioned elements may be communicatively coupled to each other with e.g. an internal bus. The memory unit 520 may store and maintain portions of a computer program (code) 525, the rope condition model 402, the condition data 404, the current state condition data 406, the condition change data 408a, 408b, the actual condition data 420, the historical movement data 430, the historical actual condition data 440, and any other data. The computer program 525 may comprise instructions which, when the computer program 525 is executed by the processing unit 510 of the elevator control unit 120, 118a-118n may cause the processing unit 510, and thus the elevator control unit 120, 118a-118n to carry out desired tasks, e.g. one or more of the method steps described above and/or the operations of the elevator control unit 120, 118a-118n described above. The processing unit 510 may thus be arranged to access the memory unit 520 and retrieve and store any information therefrom and thereto. For sake of clarity, the processor herein refers to any unit suitable for processing information and control the operation of the elevator control unit 120, 118a-118n, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication interface unit 530 provides one or more communication interfaces for communication with any other unit, e.g. the external computing unit 130, the elevator group control unit 120, the elevator control units 118a-118n of the elevators 112a-112n, the at least one rope condition monitoring sensor device, one or more databases, or with any other unit. The user interface unit 540 may comprise one or more input/output (1/O) devices, such as buttons, keyboard, touch screen, microphone, loudspeaker, display and so on, for receiving user input and outputting information. The computer program 525 may be a computer program product that may be comprised in a tangible nonvolatile (non-transitory) computer-readable medium bearing the computer program code 525 embodied therein for use with a computer, i.e. the elevator control unit 120, 118a-118n.

FIG. 6 illustrates schematically an example of components of the external computing unit 130. The external computing unit 130 may comprise a processing unit 610 comprising one or more processors, a memory unit 620 comprising one or more memories, a communication interface unit 630 comprising one or more communication devices, and possibly a user interface (UI) unit 640. The mentioned elements may be communicatively coupled to each other with e.g. an internal bus. The memory unit 620 may store and maintain portions of a computer program (code) 625, the rope condition model 402, the condition data 404, the current state condition data 406, the condition change data 408a, 408b, the actual condition date 420, the historical movement data 430, the historical actual condition data 440, and any other data. The computer program 625 may comprise instructions which, when the computer program 625 is executed by the processing unit 610 of the external computing unit 130 may cause the processing unit 610, and thus the external computing unit 130 to carry out desired tasks, e.g. one or more of the method steps described above and/or the operations of the external computing unit 130 described above. The processing unit 610 may thus be arranged to access the memory unit 620 and retrieve and store any information therefrom and thereto. For sake of clarity, the processor herein refers to any unit suitable for processing information and control the operation of the external computing unit 130, among other tasks. The operations may also be implemented with a microcontroller solution with embedded software. Similarly, the memory unit 620 is not limited to a certain type of memory only, but any memory type suitable for storing the described pieces of information may be applied in the context of the present invention. The communication interface unit 630 provides one or more communication interfaces for communication with any other unit, e.g. the elevator group control unit 120, one or more databases, or with any other unit. The user interface unit 640 may comprise one or more input/output (1/O) devices, such as buttons, keyboard, touch screen, microphone, loudspeaker, display and so on, for receiving user input and outputting information. The computer program 625 may be a computer program product that may be comprised in a tangible nonvolatile (non-transitory) computer-readable medium bearing the computer program code 625 embodied therein for use with a computer, i.e. the external computing unit 130.

The specific examples provided in the description given above should not be construed as limiting the applicability and/or the interpretation of the appended claims. Lists and groups of examples provided in the description given above are not exhaustive unless otherwise explicitly stated.

1. A method for providing condition data of an elevator rope,
wherein the method comprising:
using current state condition data representing a condition of the elevator rope for the length of the elevator rope in a current state and condition change data indicating at least one potential change in the condition of the elevator rope as input data of a rope condition model;
processing the input data with the rope condition model to provide output data comprising condition data of the elevator rope in a new state; and
utilizing the provided condition data of the elevator rope to update the current state condition data or in an elevator call allocation process.

2. The method according to claim 1, wherein the condition change data comprises movement data of at least one realized movement cycle of the elevator car, and wherein the provided condition data is utilized to update the current state condition data.

3. The method according to claim 1, wherein the condition change data comprises movement data of at least one predicted movement cycle of the elevator car, and wherein the provided condition data is utilized in the elevator call allocation process.

4. The method according to claim 1 further comprising discretizing the elevator rope by dividing the elevator rope into a plurality of rope segments.

5. The method according to claim 1 further comprising updating the provided condition data by using actual condition data of the elevator rope.

6. The method according to claim 1 further comprising training the rope condition model by using historical movement data of realized movement cycles and/or historical actual condition data.

7. The method according to claim 5, wherein the actual condition data and/or the historical actual condition data are obtained by at least one rope condition monitoring sensor device arranged inside an elevator shaft and/or by a rope condition monitoring sensor device operated by a user during a maintenance visit.

8. The method according to claim 7, wherein the at least one rope condition monitoring sensor device is a rope diameter monitoring device.

9. The method according to claim 1, wherein the condition of the elevator rope is expressed as a rope condition count of the elevator rope for the length of the elevator rope or as rope diameter data representing a diameter of the elevator rope for the length of the elevator rope.

10. An elevator computing system for providing condition data of an elevator rope, the elevator computing system comprising:
a processing unit comprising at least one processor; and
a memory unit comprising at least one memory including computer program code;
wherein the at least one memory and the computer program code are configured to, with the at least one processor, cause the elevator computing system to perform:
use current state condition data representing a condition of the elevator rope for the length of the elevator rope in a current state and condition change data indicating at least one potential change in the condition of the elevator rope as input data of a rope condition model,
process the input data with the rope condition model to provide output data comprising condition data of the elevator rope in a new state, and
utilize the provided condition data of the elevator rope to update the current state condition data or in an elevator call allocation process.

11. The elevator computing system according to claim 10, wherein the condition change data comprises movement data of at least one realized movement cycle of the elevator car, and wherein the elevator computing system is configured to utilize the provided condition data to update the current state condition data.

12. The elevator computing system according to claim 10, wherein the condition change data comprises movement data of at least one predicted movement cycle of the elevator car, and wherein the elevator computing system is configured to utilize the provided condition data in the elevator call allocation process.

13. The elevator computing system according to claim 10 configured to discretize the elevator rope by dividing the elevator rope into a plurality of rope segments.

14. The elevator computing system according to any claim 10 further configured to update the provided condition data by using actual condition data the elevator rope.

15. The elevator computing system according claim 10, further configured to train the rope condition model by using historical movement data of movement cycles and/or historical actual condition data.

16. The elevator computing system according to claim 14, wherein the actual condition data and/or the historical actual condition data are obtained by at least one rope condition monitoring sensor device arranged inside an elevator shaft and/or by a rope condition monitoring sensor device operated by a user during a maintenance visit.

17. The elevator computing system according to claim 16, wherein the at least one rope condition monitoring sensor device is a rope diameter monitoring device.

18. The elevator computing system according to claim 10, wherein the condition of the elevator rope is expressed as a rope condition count of the elevator rope for the length of the elevator rope or rope diameter data representing a diameter of the elevator rope for the length of the elevator rope.

19. A non-transitory computer program product for providing condition data of an elevator rope which, when executed by at least one processor, cause a computer to perform the method according to claim 1.

20. The method according to claim 2 further comprising discretizing the elevator rope by dividing the elevator rope into a plurality of rope segments.
